(19) United States
(12) Patent Application Publication
(10) Pub. No.: US 2004/0049370 A1
(43) Pub. Date: Mar. 11, 2004

(54) Self adjusting linear MOSFET simulation techniques

(75) Inventors: Douglas R. Stanley, Sunnyvale, CA (US); Anuj Trivedi, San Jose, CA (US)

Correspondence Address: David B. Ritchie, Thelen Reid & Priest LLP, P.O. Box 640640, San Jose, CA, 95164-0640, US

(73) Assignee: Sun Microsystems, Inc., a Delaware Corporation

(21) Appl. No.: 10/235,213

(22) Filed: Sep. 5, 2002

(51) Int. Cl. G06F 17/50

(52) U.S. Cl. 703/14

(57) ABSTRACT

A method of circuit simulation of an overall circuit including at least one nonlinear component and a plurality of fixed linear components. The process begins by obtaining a netlist for the overall circuit. Next, one or more of the individual nonlinear components from the netlist are precharacterized. Generally the precharacterization is performed in advance of the circuit simulation and the results are stored in a table. The overall circuit is broken into one or more subcircuits. The number and size of the subcircuits will depend on the circumstances. The nonlinear components are substituted with equivalent linear components based on the precharacterization. A simulation matrix is built. Generally the matrix is carefully partitioned to reduce the number of calculations. A simulation is run for each of the subcircuits. Finally, the subcircuit simulations are combined to form the overall circuit simulation.

### FIELD OF THE INVENTION

The present invention relates generally to circuit simulation techniques. More specifically, the present invention relates to transistor level self adjusting linear MOSFET circuit simulation techniques.

### BACKGROUND OF THE INVENTION

Circuit simulation is an important aspect of integrated circuit (IC) design. This is especially true for very large scale integration (VLSI) ICs. Performing circuit simulation gives one the high level of confidence in a design that is required before one would even consider the expensive process of manufacturing the IC. Typically, the amount of data for an IC design may be massive. Hence performing transistor level circuit simulation on the overall IC has proven practically impossible in a reasonable amount of time with finite computer resources. The conventional response has been to perform different types of circuit simulations at different levels of abstraction. The most expensive transistor level circuit simulation has been reserved to the less traditional instances or the most critical portions of the IC design. However, over time, competitive IC performance pressures have driven IC designers to rely increasingly on less traditional design instances. Further, IC manufacturing techniques continue to enable smaller and smaller feature sizes. As a result, more abstract circuit simulation tools have become less capable of providing the confidence needed in a design. For example, one can no longer accurately determine the electromigration risk of circuit interconnects in deep submicron technology using only total capacitance and activity factors. Integration of the currents must be calculated and used with more elaborate design rules for circuit simulation.

Less abstract circuit simulators are highly computer intensive due at least in part to the requirement that they be able to handle nonlinear components in the IC design. Such nonlinear components include MOSFET transistors. These components are expressed by nonlinear equations that are solved iteratively using approaches such as the Newton-Raphson method. Thus for a single time step, many iterations may be needed to solve the various equations. When one multiplies this by the number of time steps used in a single simulation and then by the number of simulations needed to cover the IC design, then one can see how the cost may become staggering. By increasing the level of abstraction, a more acceptable balance between cost and accuracy can be reached.

### BRIEF DESCRIPTION OF THE INVENTION

A method of circuit simulation of an overall circuit including at least one nonlinear component and a plurality of fixed linear components is disclosed. The process begins by obtaining a netlist for the overall circuit. Next, one or more of the individual nonlinear components from the netlist are precharacterized. Generally the precharacterization is performed in advance of the circuit simulation and the results are stored in a table. The overall circuit is broken into one or more subcircuits. The number and size of the subcircuits will depend on the circumstances. The nonlinear components are substituted with equivalent linear components based on the precharacterization. A simulation matrix is built. Generally the matrix is carefully partitioned to reduce the number of calculations. A simulation is run for each of the subcircuits. Finally, the subcircuit simulations are combined to form the overall circuit simulation.

### BRIEF DESCRIPTION OF THE DRAWINGS

The accompanying drawings, which are incorporated into and constitute a part of this specification, illustrate one or more exemplary embodiments of the present invention and, together with the detailed description, serve to explain the principles and exemplary implementations of the invention.

In the drawings:

FIG. 1 is a schematic diagram of a MOSFET transistor and a linear model of the MOSFET transistor;

FIG. 2 is a schematic diagram of an example precharacterization simulation set up for the MOSFET transistor of FIG. 1;

FIG. 3 is a current versus voltage graph of curves formed by the data points from the simulation of the MOSFET transistor of FIG. 1;

FIG. 4 is a schematic diagram of a circuit to be simulated according to an embodiment of the present invention;

FIG. 5 is a schematic diagram of an equivalent linear subcircuit to the nonlinear subcircuit of FIG. 4; and

FIG. 6 is a block flow diagram of a circuit simulation technique according to an embodiment of the present invention.

### DETAILED DESCRIPTION OF THE INVENTION

Various exemplary embodiments of the present invention are described herein in the context of transistor level self adjusting linear MOSFET circuit simulation techniques. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to exemplary implementations of the present invention as illustrated in the accompanying drawings. The same reference indicators will be used throughout the drawings and the following detailed descriptions to refer to the same or like parts.

In the interest of clarity, not all of the routine features of the exemplary implementations described herein are shown and described. It will of course, be appreciated that in the development of any such actual implementation, numerous implementation-specific decisions must be made in order to achieve the specific goals of the developer, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems, computing platforms, firmware, computer programs, computer languages, and/or general-purpose machines. The method can operate as a programmed process running on processing circuitry. The processing circuitry can take the form of numerous combinations of processors and operating systems or the form of a stand-alone device. The process can be implemented as instructions executed by such hardware, hardware alone, or any combination thereof. The software may be stored on a computer-readable medium.

In addition, one of ordinary skill in the art will recognize that devices of a less general purpose nature, such as hardwired devices, field programmable logic devices (FPLDs), including field programmable gate arrays (FPGAs) and complex programmable logic devices (CPLDs), application specific integrated circuits (ASICs), or the like, may also be used without departing from the scope and spirit of the inventive concepts disclosed herein.

In accordance with one embodiment of the present invention, the method may be implemented on a data processing computer. The method may also be implemented in a computing environment including various peripherals such as input devices, output devices, displays, pointing devices, memories, storage devices, media interfaces for transferring data to and from the computer, and the like. In addition, the computing environment may be networked.

As opposed to nonlinear equations discussed above, solving linear equations is less cost intensive. One can easily solve linear equations in one pass using linear algebraic numerical methods. To take advantage of this fact, one form of abstraction for circuit simulation can be achieved by replacing the nonlinear components with linear approximations. For example, a MOSFET transistor can be replaced with equivalent resistance and capacitance components. Accordingly, more abstract circuit simulators can be made at least somewhat less computer intensive then their less abstract counterparts.

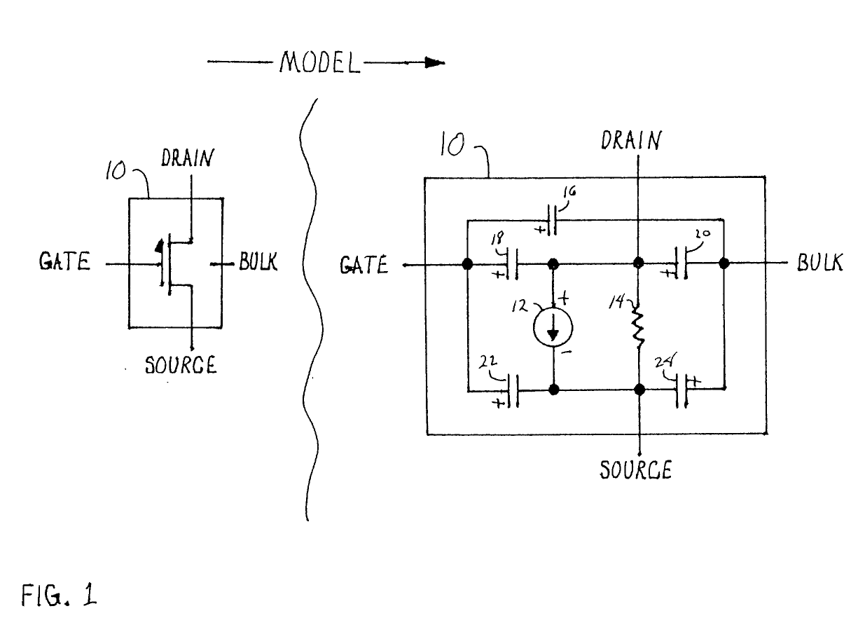

Turning first to FIG. 1, a schematic diagram of a MOSFET transistor 10 and a linear model of the MOSFET transistor 10 is shown. FIG. 1 is presented as one example. Other nonlinear components can also be modeled in a similar fashion with linear components. Further, the model transistor shown is not the exclusive manner in which to model a transistor. One of ordinary skill in the art will be able to devise other examples analogous to that of FIG. 1. The MOSFET has connections to the drain, gate, and source terminals and to the bulk silicon. The channel of the transistor is modeled by a current source 12 from the drain to the source (I_{DS}) in parallel with a resistance 14 from the drain to the source (R_{DS}). The capacitance effects at the respective terminals are modeled by five capacitors. A first capacitor 16 is coupled between the gate and the bulk (C_{GB}). A second capacitor 18 is coupled between the gate and the drain (C_{GD}). A third capacitor 20 is coupled between the drain and the bulk (C_{DB}). A fourth capacitor 22 is coupled between the gate and the source (C_{GS}). A fifth capacitor 24 is coupled between the source and the bulk (C_{SB}). The question becomes what value to give these linear components. While it is possible to give them only one static value each, this compromises the accuracy of the linear approximation. Generally, one may find the compromise to be too great to maintain acceptable accuracy. A better option is to adjust the values of the linear components during the circuit simulation. This will better approximate the nonlinear behavior but still allow a purely linear numerical solution. The values for each of the linear components in the model can be obtained empirically by performing nonlinear DC simulations of the MOSFET transistor 10 and creating a precharacterization look-up table for the various values. The various values may be organized and stored in any number of ways and in any number of locations.

Depending on the number of different nonlinear components in an IC design, it may become impractical to create precharacterization tables for each different one. In such a case, an appropriate method of interpolation between tables could be necessary. For the best results, such interpolation would be limited to differences in the width and length of the component and not differences in the doping or other profound differences in the material properties or structure of the component. One approach is to run characterizations recursively across decreasing ranges between two points. For example, one point represents a stronger transistor and the other point represents a weaker transistor. The first invocation runs across the entire range of the design and measures the greatest interpolation error at an intermediate point. If the error exceeds a specified tolerance, then the range is divided into parts and each subrange is recursively processed as with the entire range. Generally the precharacterization tables are created in advance of the circuit simulation and stored. The desired accuracy of the circuit simulation may influence the selection and number of tables.

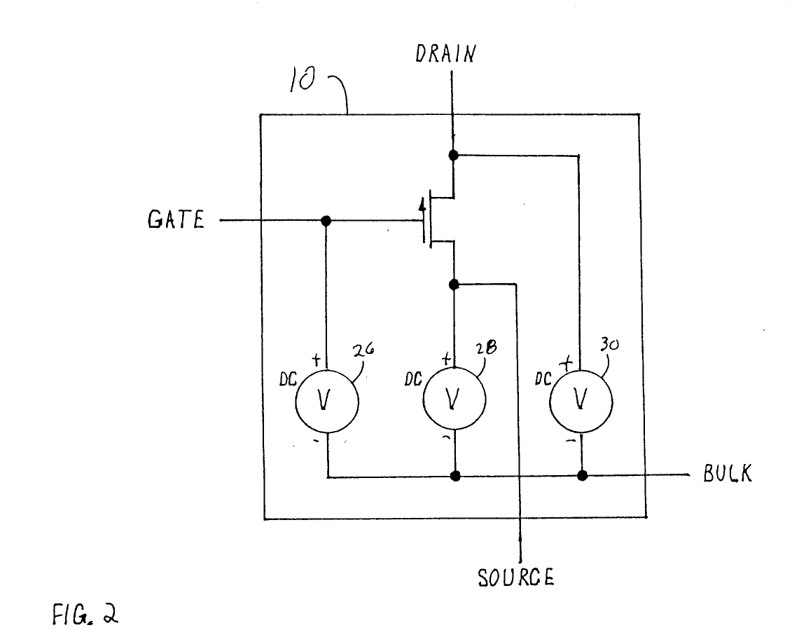

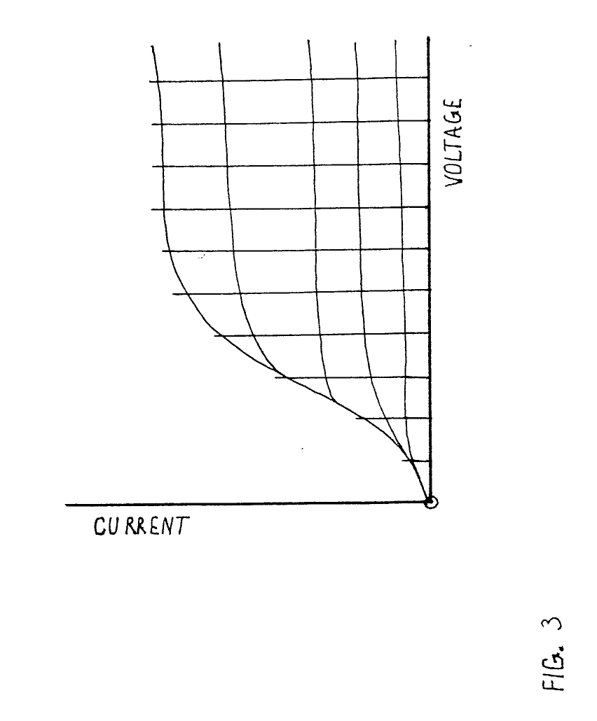

Turning now to FIG. 2, a schematic diagram of an example precharacterization simulation set up for the MOSFET transistor 10 of FIG. 1 is shown. The set up includes three DC voltages sources. A first DC voltage source 26 is coupled between the gate and the bulk, a second DC voltage source 28 is coupled between the source and the bulk, and a third DC voltage source 30 is coupled between the drain and the bulk. The values of the three voltage sources are swept through a range and the characteristics are extracted from the nonlinear simulation at each sweep point. The DC capacitance values for the five capacitors 16, 18, 20, 22, and 24 of FIG. 1 can be extracted empirically using small signal AC analysis on the transistor terminals for various DC biasing. The data for each sweep point can be plotted to form a series of curves on a current versus voltage (IV) graph such as the example shown in FIG. 3. The value of the resistor 14 of FIG. 1 is calculated as the derivative of the voltage with respect to the current. This resistor 14 will then draw a current proportional to the voltage and inversely proportional to its resistance value. The value of the current source 12 of FIG. 1 is then calculated as being the additional offset current needed to achieve the current value on the curve for a corresponding voltage value. The accuracy of the component values will depend in part on the number of sweep points. For better accuracy, more sweep points should be taken in the nonlinear region of the curves, that is, the sweep points may not be uniformly distributed along the curve.

Once the values for the components of FIG. 1 are determined, they can be placed in the precharacterization look-up table indexed by the DC voltages at the transistor terminals. During the circuit simulation these component values are fetched from the table indexed by the terminal voltages calculated during the circuit simulation at each simulation step and replaced in the circuit for the next simulation step. The voltages can either be used as is from the previous simulation step or they can be predicted using first or higher order derivatives of the voltages from the previous step. Iterations can also be run to converge the voltages to an exact and stable value however this is not necessary for reasonable accuracy and one might as well use the Newton-Raphson method if iterations are to be performed as part of the circuit simulation.

At least one of two tradeoffs between accuracy and memory requirements can optionally be made at this point. First, it is generally the case that MOSFET transistors can be treated as symmetrical devices with respect to the source and drain terminals, thus the source can be swept from the lowest to the highest voltages expected in the circuit simulation while the drain need only be swept starting from the source voltage. Table symmetry can then be used for values outside of this range. Second, it is possible to fix the source voltage and only sweep the drain voltage. Although this will prohibit the characterization of the body effect of the transistor, it will generate a two dimensional table saving considerable memory over a three dimensional table that might otherwise be required. Further, this option will in most cases result in a stronger model transistor than in reality which may lead to a more optimistic or pessimistic circuit simulation result depending on the particular application.

Once the linear components have been substituted for the nonlinear components by way of the look-up tables, the circuit simulation equations become purely linear and can be solved using modified nodal analysis techniques of resistance-inductance-capacitance (RLC) circuits. Traditionally this involves creating a stamp for each component and inserting that stamp appropriately in a system matrix. The circuit simulation equations are then solved through the following linear algebraic relationship:

Ax=y Equation 1

where A is the system matrix, x is a vector containing the node voltages to solve for, and y is a vector containing current sources into the nodes. The y vector is commonly referred to as the right hand side of the equation.

For an RLC circuit, the stamps produced for each component are predictable. The resistor stamps always have a fixed system matrix portion and capacitor and inductor stamps always have a fixed system matrix portion for a fixed time step and a variable right hand side that is a function of the node voltages. When the time step is fixed, then the procedure to simulate the circuit is to repeatedly solve Equation 1 with a constant system matrix and multiple right hand sides. The linear algebraic technique of matrix decomposition can be used in such cases to gain numerical efficiency. For example, if multiple (k) simulation steps are to be run, then directly solving the matrix at each step would have a total cost of O(kn³) where n is the total number of nodes. However, using matrix decomposition, the cost reduces to the cost of factoring the matrix once O(n³) plus the cost of backsolves for each time step O(2kn²) for a total cost of O(n³+2kn²). In most practical applications, the latter will be less costly than the former. Furthermore, if branch equations and voltage sources are disallowed, then the matrix will also be symmetric positive definite. In such case, additional optimizations can be achieved using the technique known as Cholesky factorization which will reduce the complexity and memory usage by about one half. If it is the situation that voltage sources are present, then they can be easily transformed into current sources using Norton's theorem as required.

At this point, a review of the methods used to model the transistor reveals an issue that ought to be considered in more detail. It is such that the values for the components of the transistor model of FIG. 1 will change with the terminal voltages which will in turn cause the system matrix to change. Consequently, if matrix decomposition is to be used, then the matrix might have to be factored at each simulation step. This would produce a total cost of O(k(n³+n²)) which is worse than just solving the matrix directly. This result would of course defeat the purpose of the entire exercise. Fortunately, it is possible to avoid this result. One needs to consider that for most practical cases the RLC network of a VLSI circuit represents the distributed parasitic of the interconnect. The nodes associated with these will likely far outnumber the nodes associated with the transistor terminals. Given this, one way to avoid the above result is through careful partitioning of the matrix. If the matrix is partitioned in such a way that the nodes associated with the components from the transistor model are grouped together as the diagonal in a principal submatrix and the nodes associated with the fixed linear components are grouped together as the diagonal in the leading principal submatrix, then block factorization can be used without the above result. The cost of block factorization after the initial matrix factorization is typically O(m³+l²) where m plus 1 equal n and m represents the number of nodes connected to components from the transistor model and l represents the number of nodes connected to fixed linear components. Utilizing the partitioned matrix, the total cost of simulation is then the sum of the cost of the initial matrix factorization O((m+l)³) plus the cost of the block factorization O(k(m³+l²)) plus the cost of the backsolves O(2k(m+1)²). In typical circuits where the number of transistor model nodes is much less than the number of linear component nodes and the number of linear nodes is nearly equal to the total number of nodes, then the total cost is approximately equal to O(n³+3kn²). This total is not much worse than the above strict matrix decomposition total cost of O(n³+2kn²).

Practically speaking even though the substitution of linear components for nonlinear components makes the calculations less complex, the number of calculations may still be too unwieldy to be performed as a single circuit simulation. The resulting matrix might still be too big to solve. Reducing the size of the circuit would reduce the size of the matrix. Fortunately, it is possible to effectively isolate portions of the overall circuit as subcircuits and simulate them individually. The simulations of the subcircuits are then combined to form the simulation of the overall circuit. For discussion purposes, the use of the terms overall circuit and subcircuit are relative. The overall circuit may not necessarily be the entire VLSI IC. It may be that only a portion of the entire IC is being simulated. This portion could then be referred to as the overall circuit in the sense that no more circuit is being simulated. The subcircuit will generally be something less than the overall circuit. The number and size of the subcircuits will depend on the circumstances. The selection of subcircuits can be performed in a number of ways. One way is to consider that one can reasonably assume that for MOSFET technology, networks connected from gate-to-source or from gate-to-drain can be somewhat isolated from each other. Completely isolating them could be problematic due to a product known as the miller effect of the transistor. The potential problem is that if the loading is not accounted for, then a maximum miller effect is realized which may be optimistic or pessimistic depending upon the circumstances. However, as long as the load of the source and drain are accounted for, the various subcircuits can be simulated independently.

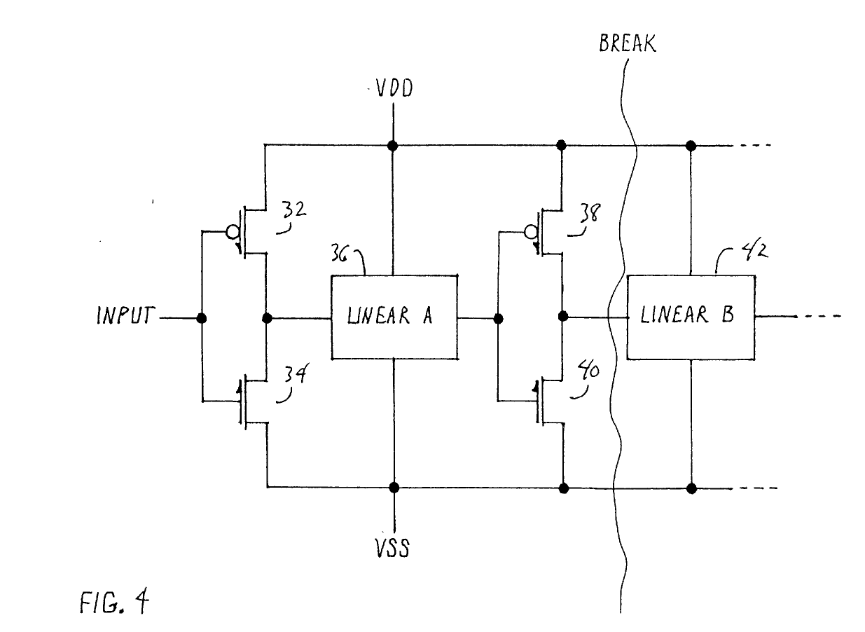

Turning now to FIG. 4, a schematic diagram of a circuit to be simulated according to an embodiment of the present invention is shown. FIG. 4 is presented as one example. The overall circuit is not shown in the interest of clarity. In the present example, the circuit includes an input which would not necessarily be the case. One of ordinary skill in the art will be able to devise other examples analogous to that of FIG. 4. The circuit includes a first transistor 32, a second transistor 34, a collection of one or more fixed linear components labeled Linear A 36, a third transistor 38, a fourth transistor 40, and Linear B 42. The blocks Linear A 36 and Linear B 42 may contain any number and arrangement of linear components. It is not necessarily the case that Linear A 36 or Linear B 42 will be connected to V_{DD}, V_{SS}, or both. While the details of the components within Linear A 36 or Linear B 42 are used for the actual circuit simulation, such details are not necessary for the present discussion. It should not be implied that the linear components are necessarily replaced by one or more equivalent components although this might be possible or desirable to at least some extent in certain circumstances. In the present example, the third and fourth transistors 38 and 40 provide a potential location at which to break the overall circuit into a subcircuit. Other subcircuits, one including Linear B for example, will likely exist but are not shown. If the overall circuit is broken into multiple subcircuits, then it may be possible to run the simulation of two or more of the subcircuits in parallel to reduce total run time. It may also be the case that two or more of the subcircuits must be simulated in series based on overall circuit dynamics. Recall that the simulations of the subcircuits are combined to form the simulation of the overall circuit.

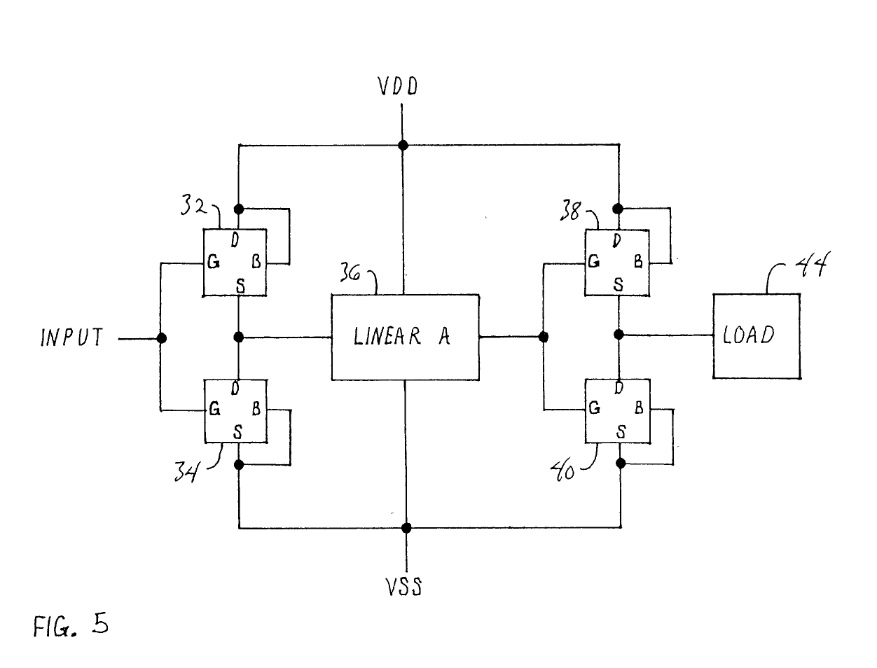

Turning now to FIG. 5, a schematic diagram of an equivalent linear subcircuit to the nonlinear subcircuit of FIG. 4 is shown. Linear A 36 is already linear and is included from FIG. 4. The first, second, third, and fourth transistors 32, 34, 38, and 40 are each replaced with the model transistor 10 of FIG. 1. Also included is a load 44 which is selected to account for the miller effect discussed above. As shown, the equivalent subcircuit can be simulated independently of the overall circuit from which it came. Further, the equivalent subcircuit contains only linear elements which reduces calculation complexity.

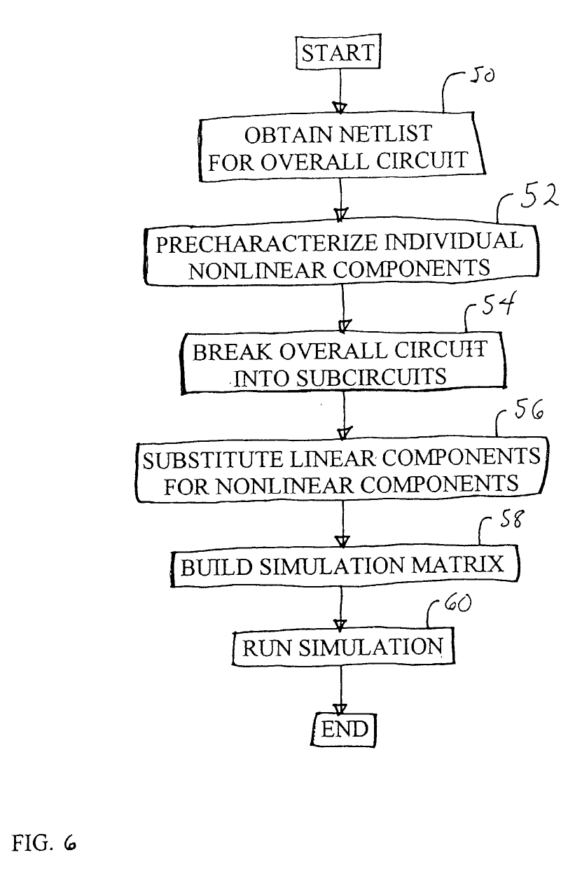

Turning now to FIG. 6, a block flow diagram of a circuit simulation technique according to an embodiment of the present invention is shown. The process begins with START. At block 50, the netlist for the overall circuit is obtained. The netlist will contain both linear and nonlinear components. At block 52, one or more of the individual nonlinear components from the netlist are precharacterized. Recall that generally the precharacterization is performed in advance and that the results are stored in a table but that not every nonlinear component may have a table. At block 54, the overall circuit is broken into one or more subcircuits. Recall that the number and size of the subcircuits will depend on the circumstances. At block 56, the nonlinear components are substituted with the equivalent linear components. At block 58, the simulation matrix is built. Recall that generally the matrix is carefully partitioned to reduce the number of calculations. At block 60, the simulation is run and then the process ENDS.

It should be noted that the diagram of FIG. 6 is presented as one example. The number and order of the blocks are not strictly limited to that shown. One or more of the blocks may be combined or repeated with one or more of the other blocks. Blocks 50 and 52 may be characterized as pre-simulation activity and separated from the other blocks. The order of blocks 54 and 56 might be reversed. They might also be broken into multiple blocks for each subcircuit or nonlinear component. Block 58 might involve multiple matrices either as a single block or as multiple blocks. Likewise, block 60 might involve multiple runs either as a single block or as multiple blocks. In the case of multiple blocks, the blocks might be in parallel, in series, or both. A complete simulation may require multiple simulations using different settings. Whatever the number and order of the blocks or the number of simulations, the same result should be achievable through careful circuit simulation design. Utilizing the above techniques, transistor level circuit simulation of the overall circuit is feasible. Although some tradeoffs in accuracy arise due to increased abstraction, these tradeoffs have generally been found to be negligible in most applications.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method of circuit simulation of an overall circuit including at least one nonlinear component and a plurality of fixed linear components, the method comprising:
breaking the overall circuit into at least one subcircuit including the at least one nonlinear component;
substituting at least one linear component for the at least one nonlinear component;
building a simulation matrix for the at least one subcircuit, wherein the matrix is partitioned based at least in part on the at least one linear component substituted for the at least one nonlinear component; and
running a simulation of the at least one subcircuit.

2. The method as defined in claim 1, wherein breaking the overall circuit comprises:
identifying an isolation zone between the subcircuit and the overall circuit; and
accounting for isolation effects of the overall circuit on the subcircuit in the subcircuit.

3. The method as defined in claim 1, further comprising precharacterizing the at least one nonlinear component.

4. The method as defined in claim 3, further comprising storing the precharacterization of the at least one nonlinear component in a table.

5. The method as defined in claim 3, further comprising utilizing the precharacterization of the at least one nonlinear component in the determination of the at least one linear component substituted for the at least one nonlinear component.

6. A method of circuit simulation of an overall circuit including at least one MOSFET transistor and a plurality of fixed linear components, the method comprising:
breaking the overall circuit into at least one subcircuit including the at least one MOSFET transistor;
substituting at least one linear component for the at least one MOSFET transistor;
building a simulation matrix for the at least one subcircuit, wherein the matrix is partitioned based at least in part on the at least one linear component substituted for the at least one MOSFET transistor; and
running a simulation of the at least one subcircuit.

7. The method as defined in claim 6, wherein breaking the overall circuit comprises:
identifying an isolation zone between the subcircuit and the overall circuit, wherein the isolation zone is based at least in part on the at least one MOSFET transistor; and
accounting for isolation effects of the overall circuit on the subcircuit in the subcircuit.

8. The method as defined in claim 6, further comprising precharacterizing the at least one MOSFET transistor.

9. The method as defined in claim 8, further comprising storing the precharacterization of the at least one MOSFET transistor in a table.

10. The method as defined in claim 8, further comprising utilizing the precharacterization of the at least one MOSFET transistor in the determination of the at least one linear component substituted for the at least one MOSFET transistor.

11. An apparatus for circuit simulation of an overall circuit including at least one nonlinear component and a plurality of fixed linear components, the apparatus comprising:
means for breaking the overall circuit into at least one subcircuit including the at least one nonlinear component;
means for substituting at least one linear component for the at least one nonlinear component;
means for building a simulation matrix for the at least one subcircuit, wherein the matrix is partitioned based at least in part on the at least one linear component substituted for the at least one nonlinear component; and
means for running a simulation of the at least one subcircuit.

12. The apparatus as defined in claim 11, wherein the means for breaking the overall circuit comprises:
means for identifying an isolation zone between the subcircuit and the overall circuit; and
means for accounting for isolation effects of the overall circuit on the subcircuit in the subcircuit.

13. The apparatus as defined in claim 11, further comprising means for precharacterizing the at least one nonlinear component.

14. The apparatus as defined in claim 13, further comprising a table for storing the precharacterization of the at least one nonlinear component.

15. The apparatus as defined in claim 13, further comprising means for utilizing the precharacterization of the at least one nonlinear component in the determination of the at least one linear component substituted for the at least one nonlinear component.

16. An apparatus for circuit simulation of an overall circuit including at least one MOSFET transistor and a plurality of fixed linear components, the apparatus comprising:
means for breaking the overall circuit into at least one subcircuit including the at least one MOSFET transistor;
means for substituting a linear approximation for the at least one MOSFET transistor;
means for building a simulation matrix for the at least one subcircuit, wherein the matrix is partitioned based at least in part on the linear approximation substituted for the at least one MOSFET transistor; and
means for running a simulation of the at least one subcircuit.

17. The apparatus as defined in claim 16, wherein the means for breaking the overall circuit comprises:
means for identifying an isolation zone between the subcircuit and the overall circuit, wherein the isolation zone is based at least in part on the at least one MOSFET transistor; and
means for accounting for isolation effects of the overall circuit on the subcircuit in the subcircuit.

18. The apparatus as defined in claim 16, further comprising means for precharacterizing the at least one MOSFET transistor.

19. The apparatus as defined in claim 18, further comprising a table for storing the precharacterization of the at least one MOSFET transistor.

20. The apparatus as defined in claim 18, further comprising means for utilizing the precharacterization of the at least one MOSFET transistor in the determination of the linear approximation substituted for the at least one MOSFET transistor.

21. The apparatus as defined in claim 20, wherein the linear approximation substituted for the at least one MOSFET transistor comprises:
a current source from the drain to the source;
a resistance coupled between the drain and the source;
a first capacitor coupled between the gate and the bulk;
a second capacitor coupled between the gate and the drain;
a third capacitor coupled between the drain and the bulk;
a fourth capacitor coupled between the gate and the source; and
a fifth capacitor coupled between the source and the bulk.

22. The apparatus as defined in claim 16, wherein the linear approximation substituted for the at least one MOSFET transistor comprises:
a current source from the drain to the source;
a resistance coupled between the drain and the source;
a first capacitor coupled between the gate and the drain; and
a second capacitor coupled between the gate and the source.

23. The apparatus as defined in claim 22, wherein the linear approximation substituted for the at least one MOSFET transistor further comprises:
a third capacitor coupled between the gate and the bulk;
a fourth capacitor coupled between the drain and the bulk; and
a fifth capacitor coupled between the source and the bulk.
